(19) United States
(12) Patent Application Publication
(10) Pub. No.: US 2025/0208453 A1
(43) Pub. Date: Jun. 26, 2025

(54) ANTI-PEEP MODULE AND DISPLAY DEVICE

(71) Applicant: Coretronic Corporation, Hsin-Chu (TW)

(72) Inventors: Ping-Yen Chen, Hsin-Chu (TW); Chung-Yang Fang, Hsin-Chu (TW); Wen-Chun Wang, Hsin-Chu (TW); Jen-Wei Yu, Nantou County (TW)

(73) Assignee: Coretronic Corporation, Hsin-Chu (TW)

(21) Appl. No.: 18/984,980

(22) Filed: Dec. 17, 2024

(30) Foreign Application Priority Data
Dec. 21, 2023 (CN) 202311767351.0

(51) Int. Cl. G02F 1/13; G02F 1/1335

(52) U.S. Cl. CPC G02F 1/1323; G02F 1/133504; G02F 1/133528

(57) ABSTRACT

The disclosure provides an anti-peep module and a display device. The anti-peep module includes an anisotropic diffusion film, an electrically controlled phase retarder, and a first polarizer. The anisotropic diffusion film includes a substrate, multiple first optical microstructures, and a first liquid crystal layer. The first optical microstructures are arranged along a first direction and extend in a second direction. The first liquid crystal layer directly covers the first optical microstructures. An optical axis of the first liquid crystal layer is parallel to the second direction. A difference value of a refractive index of the first optical microstructures and one of a first refractive index and a second refractive index of the first liquid crystal layer along the first direction and the second direction respectively is greater than or equal to 0.05. A first absorption axis of the first polarizer is parallel to or perpendicular to the second direction.

### CROSS-REFERENCE TO RELATED APPLICATION

This application claims the priority benefit of China application serial no. 202311767351.0, filed on Dec. 21, 2023. The entirety of the above-mentioned patent application is hereby incorporated by reference herein and made a part of this specification.

### BACKGROUND

### Technical Field

The disclosure relates to an anti-peep display technology, and more particularly, to an anti-peep module and a display device.

### Description of Related Art

Generally speaking, a display device usually has a display effect of a wide viewing angle in order to allow multiple viewers to watch together. However, in certain situations or occasions, such as browsing private web pages, confidential information, or entering passwords in public, the display effect of the wide viewing angle may easily cause an image to be peeped by others, resulting in leakage of the confidential information. In order to achieve an anti-peep effect, one method is to place a light control film (LCF) in front of a display panel to filter lights at large angles. Another method is to add an electrically controlled diffuser to achieve an electrically switchable anti-peep display. However, a diffusion effect of the electrically controlled diffuser is omnidirectional, which makes it difficult to improve display brightness within a range of a specific viewing angle (e.g., a normal viewing angle) when the display device is operated in a sharing display mode.

Another method is to electrically control the filtering of the light in an anti-peep axial direction by using a combination of an additional electrically controlled liquid crystal cell and a polarizer. The additional electronically controlled liquid crystal cell may only reduce the display brightness in an anti-peep direction to a limited extent, the anti-peep effect of the display device is limited. Therefore, how to develop a display device that is extremely convenient for switching viewing angles and has excellent anti-peep effects has become an important issue for relevant manufacturers.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, a part, or all of the above objectives or other objectives, an embodiment of the disclosure provides an anti-peep module. The anti-peep module includes an anisotropic diffusion film, an electrically controlled phase retarder, and a first polarizer. The anisotropic diffusion film includes a substrate, multiple first optical microstructures, and a first liquid crystal layer. The substrate has a disposed surface, and the first optical microstructures are disposed on the disposed surface of the substrate. The first optical microstructures are arranged along a first direction and extend in a second direction. The first direction and the second direction intersect each other, and the first direction and the second direction are parallel to the disposed surface. The first liquid crystal layer is disposed on the substrate and directly covers the first optical microstructures. An orthographic projection of an optical axis of the first liquid crystal layer on the disposed surface is parallel to the second direction. The first liquid crystal layer has a first refractive index and a second refractive index different from each other along the first direction and the second direction respectively. A difference value of a refractive index of the first optical microstructures and one of the first refractive index and the second refractive index is greater than or equal to 0.05. The electrically controlled phase retarder is disposed to overlap the anisotropic diffusion film. The first polarizer is disposed to overlap the electrically controlled phase retarder. The first polarizer has a first absorption axis, and an axial direction of the first absorption axis is parallel to or perpendicular to the second direction.

In order to achieve one, a part, or all of the above objectives or other objectives, an embodiment of the disclosure provides a display device. The display device includes a display panel and an anti-peep module. The anti-peep module is disposed to overlap the display panel and includes an anisotropic diffusion film, an electrically controlled phase retarder, and a first polarizer. The anisotropic diffusion film includes a substrate, multiple first optical microstructures, and a first liquid crystal layer. The substrate has a disposed surface, and the first optical microstructures are disposed on the disposed surface of the substrate. The first optical microstructures are arranged along a first direction and extend in a second direction. The first direction and the second direction intersect each other, and the first direction and the second direction are parallel to the disposed surface. The first liquid crystal layer is disposed on the substrate and directly covers the first optical microstructures. An orthographic projection of an optical axis of the first liquid crystal layer on the disposed surface is parallel to the second direction. The first liquid crystal layer has a first refractive index and a second refractive index different from each other along the first direction and the second direction respectively. A difference value of a refractive index of the first optical microstructures and one of the first refractive index and the second refractive index is greater than or equal to 0.05. The electrically controlled phase retarder is disposed to overlap the anisotropic diffusion film. The first polarizer is disposed to overlap the electrically controlled phase retarder. The first polarizer has a first absorption axis, and an axial direction of the first absorption axis is parallel to or perpendicular to the second direction.

In order for the aforementioned features and advantages of the disclosure to be more comprehensible, embodiments accompanied with drawings are described in detail below.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIGS. 1A and 1B are schematic cross-sectional views of a display device in different operation modes according to the first embodiment of the disclosure.

FIG. 2 is a schematic cross-sectional view of an anisotropic diffusion film according to another modified embodiment of the disclosure.

FIGS. 3A and 3B are schematic cross-sectional views of a display device in different operation modes according to the second embodiment of the disclosure.

FIGS. 4 and 5 are schematic cross-sectional views of display devices according to other modified embodiments of the disclosure.

FIGS. 6A and 6B are schematic cross-sectional views of a display device in different operation modes according to the third embodiment of the disclosure.

FIGS. 7A and 7B are schematic cross-sectional views of a display device in different operation modes according to the fourth embodiment of the disclosure.

FIGS. 8A and 8B are schematic cross-sectional views of a display device in different operation modes according to the fifth embodiment of the disclosure.

FIGS. 9A and 9B are schematic cross-sectional views of a display device in different operation modes according to the sixth embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

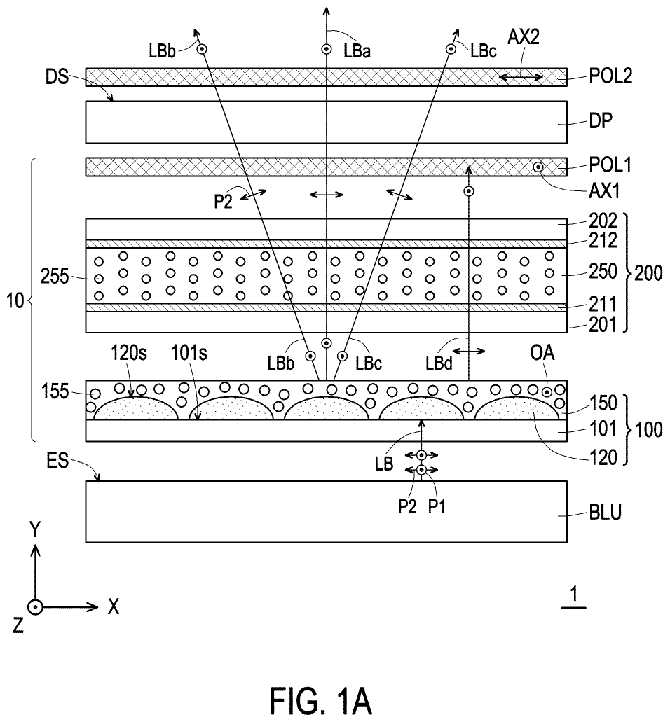

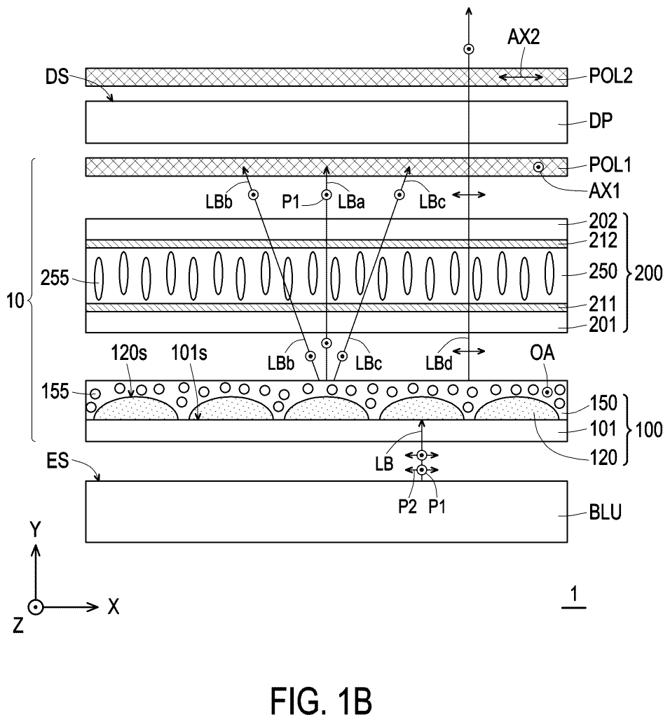

FIGS. 1A and 1B are schematic cross-sectional views of a display device in different operation modes according to the first embodiment of the disclosure. Referring to FIGS. 1A and 1B, a display device 1 includes a display panel DP and an anti-peep module 10. The anti-peep module 10 is disposed to overlap the display panel DP along a direction Y. In this embodiment, the display panel DP may be a non-self-luminous display panel, such as a liquid crystal display panel, but the disclosure is not limited thereto.

Therefore, the display device 1 may further include a backlight module BLU to serve as an illumination light source when the display panel DP displays. More specifically, the backlight module BLU has a light emitting surface ES, and the display panel DP and the anti-peep module 10 are disposed on the side of the light emitting surface ES of the backlight module BLU. In this embodiment, the anti-peep module 10 may be disposed between the display panel DP and the backlight module BLU. That is, the anti-peep module 10 is located on the side of the display panel DP facing away from a display surface DS of the display panel DP.

The anti-peep module 10 includes, for example, an anisotropic diffusion film 100, an electrically controlled phase retarder 200, and a first polarizer POL1 overlapping each other along the direction Y. The electrically controlled phase retarder 200 is disposed between the anisotropic diffusion film 100 and the first polarizer POL1. In an embodiment, the first polarizer POL1 may also be integrated with the display panel DP. That is, the display panel DP and the anti-peep module 10 may share the same polarizer. However, the disclosure is not limited thereto.

The anisotropic diffusion film 100 includes a substrate 101, multiple optical microstructures 120, and a liquid crystal layer 150. The substrate 101 has a disposed surface 101s. The optical microstructures 120 are disposed on the disposed surface 101s of the substrate 101, and the disposed surface 101s is, for example, a plane. Preferably, an in-plane phase retardation (RO) of the substrate 101 may be less than 50 nm.

For example, in this embodiment, the optical microstructures 120 may be arranged along a direction X (i.e., a first direction) and extend in a direction Z (i.e., a second direction). A length of each of the optical microstructures 120 in the direction Z is, for example, more than 10 times a width in the direction X. A cross-sectional outline of each of the optical microstructures 120 in an XY plane is, for example, semi-elliptical. The direction X and the direction Z may intersect each other (for example, be perpendicular to each other) and be parallel to the disposed surface 101s of the substrate 101. The liquid crystal layer 150 is disposed on the substrate 101 and directly covers the optical microstructures 120. In this embodiment, the liquid crystal layer 150 is, for example, formed by cured liquid crystal polymers (the liquid crystal polymers are, for example, formed by liquid crystal molecules and high molecular polymers), and an optical axis OA thereof is substantially parallel to an extension direction of the optical microstructure 120. That is, an orthographic projection of the optical axis OA of the liquid crystal layer 150 on the disposed surface 101s is parallel to the direction Z.

From another point of view, long-axis axial directions of molecules of multiple liquid crystal molecules 155 cured in the liquid crystal layer 150 (a fixed direction) are substantially arranged in parallel to an extension direction of multiple micro grooves formed between the optical microstructures 120. Therefore, the optical axis OA of the liquid crystal layer 150 has a first refractive index and a second refractive index different from each other along the direction X and the direction Z respectively. It is particularly noted that a refractive index of the optical microstructure 120 is equal to one of the first refractive index and the second refractive index. For example, in this embodiment, the refractive index of the optical microstructure 120 may be equal to the first refractive index of the liquid crystal layer 150 along the direction X, but the disclosure is not limited thereto. In another modified embodiment, the refractive index of the optical microstructure 120 may be equal to the second refractive index of the liquid crystal layer 150 along the direction Z.

In this embodiment, the first refractive index of the liquid crystal layer 150 is, for example, an ordinary refractive index, and the second refractive index thereof is, for example, an extraordinary refractive index. Preferably, a difference value of the first refractive index and the second refractive index of the liquid crystal layer 150 is greater than or equal to 0.05 (and, for example, less than 2). That is, a difference value of the refractive index of the optical microstructure 120 and one of the first refractive index and the second refractive index of the liquid crystal layer 150 is greater than or equal to 0.05.

On the other hand, the electrically controlled phase retarder 200 may include a substrate 201, a substrate 202, an alignment layer 211, an alignment layer 212, and a liquid crystal layer 250. The alignment layer 211 and the alignment layer 212 are disposed on the substrate 201 and the substrate 202 respectively. The liquid crystal layer 250 is sandwiched between the alignment layer 211 and the alignment layer 212. The liquid crystal layer 250 is, for example, formed by multiple nematic liquid crystal molecules 255, but the disclosure is not limited thereto. For example, in this embodiment, an alignment direction of the alignment layer 211 may be antiparallel to an alignment direction of the alignment layer 212, and an included angle with the direction Z is 45 degrees or 135 degrees (that is, in the electronically controlled phase retarder 200 that is not enabled, an included angle between a molecular long axis of the liquid crystal molecules 255 in the liquid crystal layer 250 and the direction Z is 45 degrees or 135 degrees). That is, the electrically controlled phase retarder 200 in this embodiment may adopt an electrically controlled birefringence (ECB) driving mode, and a variation range (electrically controlled) of a phase retardation of the liquid crystal layer 250 may be in a range of 0λ to λ/2 (e.g., greater than or equal to 0% and less than or equal to λ/2), where λ is a wavelength of a light passing through the liquid crystal layer 250. It is particularly noted that in the disclosure, the liquid crystal molecules depicted in the drawings are only schematic, and do not represent the actual arrangement and axial direction of the liquid crystal molecules.

However, the disclosure is not limited thereto. In other embodiments, the electrically controlled phase retarder may also adopt a twisted-nematic (TN), vertically-aligned (VA), or in-plane switching (IPS) driving mode, and the variation range of the phase retardation of the liquid crystal layer may be in a range of 0λ to 3λ/4. It is particularly noted that, in response to differences in the electrically controlled phase retarders, the alignment direction of the alignment layer may be designed accordingly.

It is particularly noted that, in this embodiment, an anti-peep axial direction of the display device 1 is, for example, 45 degrees or 135 degrees from an alignment direction of the liquid crystal layer 250 of the electrically controlled phase retarder 200. That is, the anti-peep axial direction in this embodiment is the direction X. A first absorption axis AX1 of the first polarizer POL1 may be parallel to the direction Z, but the disclosure is not limited thereto. In other embodiments, the first absorption axis AX1 may also be perpendicular to the direction Z (parallel to the direction X).

In this embodiment, a second polarizer POL2 may be disposed on one side of the display panel DP facing away from the electrically controlled phase retarder 200, and a second absorption axis AX2 of the second polarizer POL2 may be perpendicular to the first absorption axis AX1 of the first polarizer POL1. However, the disclosure is not limited thereto. In this embodiment, the electrically controlled phase retarder 200 is located between the anisotropic diffusion film 100 and the second polarizer POL2. In an embodiment, the second polarizer POL2 may also be integrated with the display panel DP. That is, the display panel DP and the anti-peep module 10 may share the same polarizer. However, the disclosure is not limited thereto.

Operating principles of the display device 1 is exemplarily described below.

Referring to FIG. 1A, the backlight module BLU is configured to emit a light LB toward the anti-peep module 10 and the display panel DP. The unpolarized light LB has both first linear polarization P1 (a polarization direction parallel to the direction Z) and second linear polarization P2 (a polarization direction parallel to the direction X). When the unpolarized light LB passes through the anisotropic diffusion film 100, a light component with the first linear polarization P1 in the light LB is deflected at an interface 120s between the optical microstructure 120 and the liquid crystal layer 150 due to differences in the refractive index between the optical microstructure 120 and the liquid crystal layer 150 in the direction Z. On the contrary, a light component with second linear polarization P2 in the light LB is not deflected at the interface 120s between the optical microstructure 120 and the liquid crystal layer 150 because there is no substantial difference in the refractive index between the optical microstructure 120 and the liquid crystal layer 150 in the direction X.

Specifically, the light component with the first linear polarization P1 in the light LB is scattered when passing through the anisotropic diffusion film 100 (as shown by a light LBa, a light LBb, and a light LBc), while the light component with the second linear polarization P2 in the light LB is not scattered when passing through the anisotropic diffusion film 100 (as shown by a light LBd). In this embodiment, the electronically controlled phase retarder 200 that is not enabled may have the phase retardation of λ/2. Therefore, the scattered lights LBa to LBc and the non-scattered light LBd form the lights LBa to LBc with the second linear polarization P2 and the light LBd with the first linear polarization P1 after passing through the electrically controlled phase retarder 200 that is not enabled.

In this embodiment, the first absorption axis AX1 of the first polarizer POL1 is perpendicular to the polarization direction of the second linear polarization P2 and parallel to the polarization direction of the first linear polarization P1. Therefore, the scattered lights LBa to LBc may pass through the first polarizer POL1, the display panel DP, and the second polarizer POL2, and form an emitted light with the first linear polarization P1. On the contrary, the non-scattered light LBd may not pass through the first polarizer POL1. That is, when the electrically controlled phase retarder 200 is not enabled and has the phase retardation of λ/2, only the scattered lights LBa to LBc may be emitted. That is, the light emitted from the display device 1 has a relatively large angle (for example, a range of a light emitting angle of the display device 1 is greater than a range of a light emitting angle of the backlight module BLU), and the display device 1 is operated in a sharing display mode.

Referring to FIG. 1B, when the electrically controlled phase retarder 200 is enabled (for example, the molecular long axes of most of the liquid crystal molecules 255 of the liquid crystal layer 250 may be parallel to the direction Y) and has the phase retardation of 0λ, the scattered lights LBa to LBc with the first linear polarization P1 still maintains the first linear polarization P1 after passing through the electrically controlled phase retarder 200, and thus may not pass through the first polarizer POL1. On the contrary, the non-scattered light LBd with the second linear polarization P2 still maintains the second linear polarization P2 after passing through the electrically controlled phase retarder 200, and thus may pass through the first polarizer POL1, the display panel DP, and the second polarizer POL2, and form the emitted light with the first linear polarization P1. That is, when the electrically controlled phase retarder 200 is enabled and has the phase retardation of 0λ, only the non-scattered light LBd may be emitted. That is, the light emitted from the display device 1 has a relatively small angle ((for example, the range of the light emitting angle of the display device 1 is substantially equal to the range of the light emitting angle of the backlight module BLU), and the display device 1 is operated in an anti-peep display mode.

It is particularly noted that when the display device 1 is operated in the anti-peep display mode, in addition to 0%, the phase retardation of the electrically controlled phase retarder 200 that is enabled may be an integer multiple of the wavelength.

According to FIGS. 1A and 1B, by using the electrically controlled phase retarder 200 to adjust a polarization state of the light emitted from the anisotropic diffusion film 100, a switching operation of the display device 1 between the sharing display mode and the anti-peep display mode may be more convenient. On the other hand, by disposing the anisotropic diffusion film 100, an anti-peep effect of the anti-peep module 10 and a field of view of the display device 1 in the sharing display mode may be further improved.

It should be noted that in this embodiment, although the number of liquid crystal layers of the anisotropic diffusion film 100 is one for exemplary description, it does not mean that the disclosure is limited thereto. In order to further enhance a scattering effect of the anisotropic diffusion film to meet display requirements of a wide viewing angle, the anisotropic diffusion film may also be a stacked structure of multiple sets of optical microstructures and liquid crystal layers.

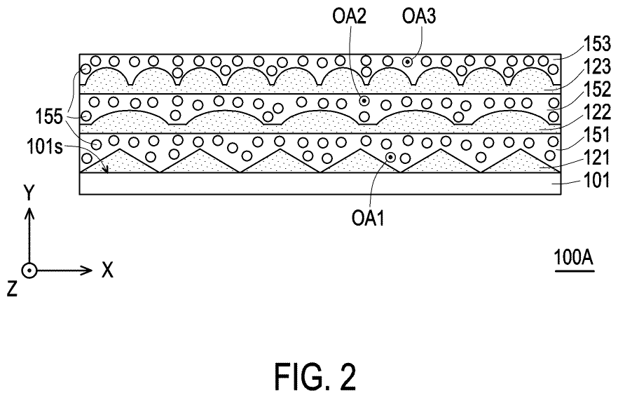

FIG. 2 is a schematic cross-sectional view of an anisotropic diffusion film according to another modified embodiment of the disclosure. As shown in FIG. 2, in an anisotropic diffusion film 100A, the number of liquid crystal layers and the number of optical microstructure layers may be plural. For example, the anisotropic diffusion film 100A may selectively include multiple first optical microstructures 121, a first liquid crystal layer 151, multiple second optical microstructures 122, a second liquid crystal layer 152, multiple third optical microstructures 123, and a third liquid crystal layer 153 sequentially disposed on the disposed surface 101s of the substrate 101.

The first optical microstructures 121 may be arranged along the direction X and extend in direction Z. The first liquid crystal layer 151 directly covers the first optical microstructures 121. The second optical microstructures 122 may be arranged along the direction X and extend in the direction Z. The second liquid crystal layer 152 directly covers the second optical microstructures 122. The third optical microstructures 123 may be arranged along the direction X and extend in the direction Z. The third liquid crystal layer 153 directly covers the third optical microstructures 123. An optical axis OA1 of the first liquid crystal layer 151, an optical axis OA2 of the second liquid crystal layer 152, and an optical axis OA3 of the third liquid crystal layer 153 are parallel to each other and are all parallel to the direction Z.

It is particularly noted that outlines of orthographic projections of the first optical microstructure 121, the second optical microstructure 122, and the third optical microstructure 123 of the anisotropic diffusion film 100A on the XY plane may be selectively different, and pitches of the first optical microstructure 121, the second optical microstructure 122, and the third optical microstructure 123 may be selectively different. For example, a cross-sectional outline of the first optical microstructure 121 may be triangular, a cross-sectional outline of the second optical microstructure 122 may be semi-elliptical, and a cross-sectional outline of the third optical microstructure 123 may be semi-circular. However, the disclosure is not limited thereto. In another modified embodiment, the cross-sectional outlines of the multi-layer optical microstructures may also be the same as each other.

On the other hand, the first liquid crystal layer 151 has a first refractive index and a second refractive index different from each other along the direction X and the direction Z respectively, and a refractive index of the first optical microstructure 121 is equal to the first refractive index or the second refractive index. The second liquid crystal layer 152 has a third refractive index and a fourth refractive index different from each other along the direction X and the direction Z respectively, and a refractive index of the second optical microstructure 122 is equal to the third refractive index or the fourth refractive index. The third liquid crystal layer 153 has a fifth refractive index and a sixth refractive index different from each other along the direction X and the direction Z respectively, and a refractive index of the third optical microstructure 123 is equal to the fifth refractive index or the sixth refractive index.

For example, in the anisotropic diffusion film 100A, the refractive index of the first optical microstructure 121 may be equal to the first refractive index of the first liquid crystal layer 151, the refractive index of the second optical microstructure 122 may be equal to the third refractive index of the second liquid crystal layer 152, and the refractive index of the third optical microstructure 123 may be equal to the fifth refractive index of the third liquid crystal layer 153. However, the disclosure is not limited thereto.

Since diffusion principles of the anisotropic diffusion film 100A are similar to diffusion principles of the anisotropic diffusion film 100 in FIG. 1A, relevant paragraphs of the aforementioned embodiment may be referred for detailed descriptions. Therefore, the same details will not be repeated in the following.

Some other embodiments are provided below to describe the invention in detail, where the same reference numerals denote the same or like components, and descriptions of the same technical contents are omitted. The aforementioned embodiment may be referred for descriptions of the omitted parts, and detailed descriptions thereof are not repeated in the following embodiment.

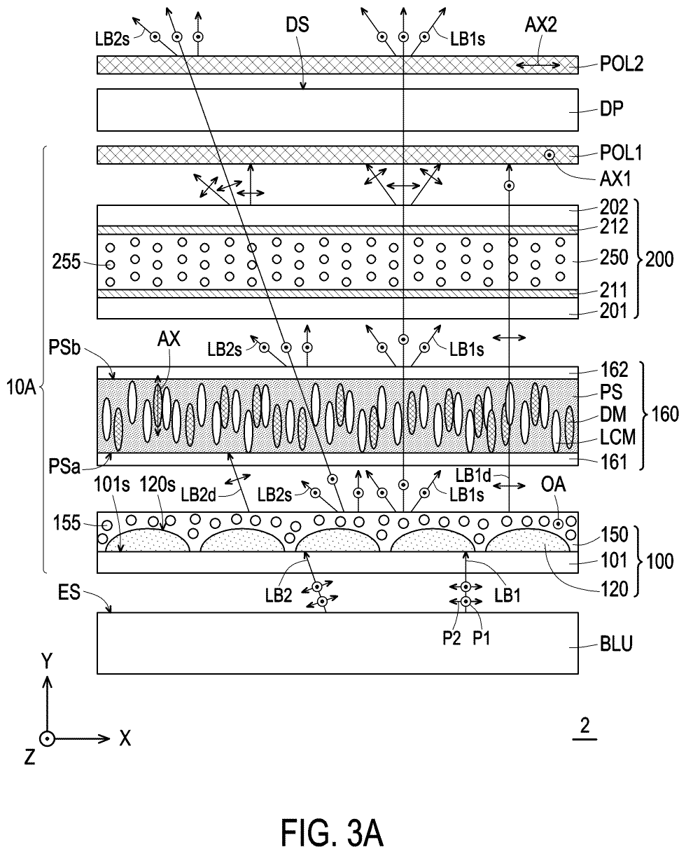

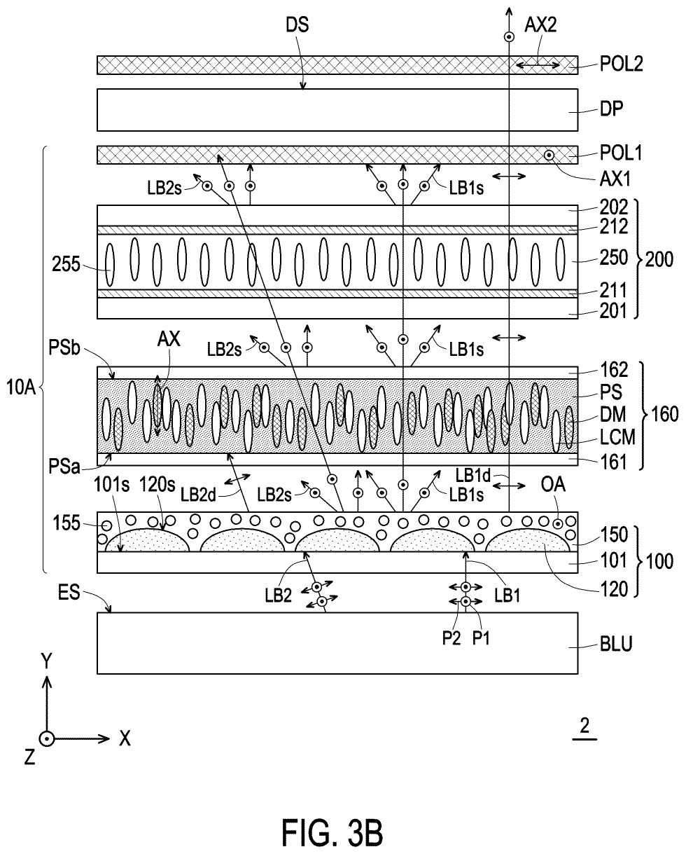

FIGS. 3A and 3B are schematic cross-sectional views of a display device in different operation modes according to the second embodiment of the disclosure. Referring to FIGS. 3A and 3B, compared to the display device 1 in FIG. 1A, an anti-peep module 10A of a display device 2 in this embodiment further includes a viewing angle limiter 160 disposed between the anisotropic diffusion film 100 and the electrically controlled phase retarder 200.

For example, the viewing angle limiter 160 may include a polymer substrate PS, multiple dye molecules DM, and multiple liquid crystal molecules LCM. The dye molecules DM and the liquid crystal molecules LCM are dispersedly disposed in the polymer substrate PS. In this embodiment, the polymer substrate PS has a substrate surface PSa, and an axial direction of an absorption axis AX of the dye molecules DM and a molecular long axis of the liquid crystal molecules LCM may be perpendicular to the substrate surface PSa of the polymer substrate PS. It is particularly noted that the dye molecules DM have a first absorption coefficient in a thickness direction (i.e., a direction perpendicular to the substrate surface PSa, such as the direction Y), and a second absorption coefficient in a direction perpendicular to the thickness direction (e.g., the direction X or the direction Z). The first absorption coefficient is different from the second absorption coefficient. It should be noted that the substrate surface PSa of the polymer substrate PS overlaps the backlight module BLU, and the thickness direction may be a normal direction of the substrate surface PSa.

In this embodiment, the first absorption coefficient of the dye molecules DM is significantly greater than the second absorption coefficient, and a ratio of the first absorption coefficient to the second absorption coefficient is between 10 and 1000. Accordingly, a filtering effect of the viewing angle limiter 160 at a side viewing angle and light transmittance in a range of the field of view may be effectively increased, thereby improving anti-peep performance of the display device 10 and overall brightness of light at other viewing angles after emitted from the display device 10. In a preferred embodiment, the ratio of the first absorption coefficient to the second absorption coefficient of the dye molecules DM may be between 100 and 1000.

In this embodiment, a material of the dye molecule DM may include an azo compound or an anthraquinone compound. A material of the liquid crystal molecule LCM may include a nematic liquid crystal material, a smectic liquid crystal material, or a discotic liquid crystal material. Under an influence of the liquid crystal molecules LCM, for example, a guest-host effect, the molecular long axes (i.e., the absorption axis AX) of the dye molecules DM dispersed between the liquid crystal molecules LCM tend to be arranged in parallel to an optical axis of the liquid crystal molecules LCM. However, the disclosure is not limited thereto. According to other embodiments, the liquid crystal molecules may also be materials having chemical functional groups similar to a structure of a dichroic dye. That is, the liquid crystal molecules LCM and the dye molecules DM in this embodiment may also be replaced by integrated dye liquid crystal molecules.

On the other hand, the viewing angle limiter 160 may further include a protective layer 161 and a protective layer 162 formed on the substrate surface PSa and a substrate surface PSb of the polymer substrate PS respectively. The protective layer 161 and the protective layer 162 may be a hard coat, a low-reflection film, an anti-reflection film, an anti-smudge film, an anti-fingerprint film, an anti-glare film, an anti-scratch film, or a composite film thereof. However, the disclosure is not limited thereto.

Since other components and configuration relationships of the display device 2 in this embodiment are similar to those of the display device 1 in FIG. 1A, relevant paragraphs of the aforementioned embodiment may be referred for detailed descriptions. Therefore, the same details will not be repeated in the following. Only differences in the operating principles between the display device 2 in this embodiment and the display device 1 in FIG. 1A will be described below.

Referring to FIG. 3A, in this embodiment, for a light LB1 incident to the anisotropic diffusion film 100 in a forward direction, the light component with the first linear polarization P1 thereof is scattered when passing through the anisotropic diffusion film 100 (as shown by a light LB1s), while the light component with the second linear polarization P2 is not scattered when passing through the anisotropic diffusion film 100 (as shown by a light LB1d) and maintains emission in the forward direction. On the other hand, for a light LB2 incident to the anisotropic diffusion film 100 in an oblique direction, the light component with the first linear polarization P1 is scattered when passing through the anisotropic diffusion film 100 (as shown by a light LB2s), while the light component with the second linear polarization P2 is not scattered when passing through the anisotropic diffusion film 100 (as shown by a light LB2d) and maintain emission at an original oblique angle.

Then, since an axial direction of the absorption axis AX of the dye molecules DM of the viewing angle limiter 160 is perpendicular to the polarization direction of the first linear polarization P1 and the polarization direction of the second linear polarization P2 of the light LB1d that is incident in the forward direction, only a portion of energy of the scattered lights LB1s and LB2s with the first linear polarization P1 and the non-scattered light LB1d is absorbed when passing through the viewing angle limiter 160. On the other hand, since the polarization direction of the second linear polarization P2 of the non-scattered light LB2d that is incident in the oblique direction is not perpendicular to the axial direction of the absorption axis AX of the dye molecules DM of the viewing angle limiter 160, the light LB2d is absorbed by the dye molecules DM when passing through the viewing angle limiter 160. Absorption efficiency of the viewing angle limiter 160 for the light LB2d increases as an included angle between the polarization direction of the second linear polarization P2 and the absorption axis AX of the dye molecules DM decreases (that is, the greater the oblique incident angle of the light LB2d).

In this embodiment, the electronically controlled phase retarder 200 that is not enabled may have the phase retardation of W2. Therefore, the scattered lights LB1s and LB2s and the non-scattered light LB1d form the lights LB1s and LB2s with the second linear polarization P2 and the light LB1d with the first linear polarization P1 after passing through the electrically controlled phase retarder 200 that is not enabled.

In this embodiment, the first absorption axis AX1 of the first polarizer POL1 is perpendicular to the polarization direction of the second linear polarization P2 and parallel to the polarization direction of the first linear polarization P1. Therefore, the scattered lights LB1s and LB2s may pass through the display panel DP and form the emitted light with the first linear polarization P1. On the contrary, the non-scattered light LB1d may not pass through the first polarizer POL1. That is, when the electrically controlled phase retarder 200 is not enabled and has the phase retardation of λ/2, only the scattered lights LB1s and LB2s may be emitted. That is, the display device 2 is operated in the sharing display mode.

Referring to FIG. 3B, when the electrically controlled phase retarder 200 is enabled and has the phase retardation of 0λ, the scattered lights LB1s and LB2s with the first linear polarization P1 still maintain the first linear polarization P1 after passing through the electrically controlled phase retarder 200, and thus may not pass through the first polarizer POL1. On the contrary, the non-scattered light LB1d with the second linear polarization P2 still maintains the second linear polarization P2 after passing through the electrically controlled phase retarder 200, and thus may pass through the first polarizer POL1, the display panel DP, and the second polarizer POL2 and form the emitted light with the first linear polarization P1. That is, when the electrically controlled phase retarder 200 is enabled and has the phase retardation of 0λ, only the non-scattered light LB1d may be emitted. That is, the display device 2 is operated in the anti-peep display mode.

It is particularly noted that compared to the anti-peep module 10 in FIGS. 1A and 1B, the anti-peep module 10A in this embodiment may limit a large-angle light beam emitted by the backlight module BLU by a configuration of the viewing angle limiter 160, thereby further improving an anti-peep effect of the display device 2. In addition, the viewing angle limiter 160 in this embodiment may further significantly improve an issue of light energy loss of a current anti-peep sheet at a normal viewing angle, which helps to improve anti-peep display brightness of the display device 2.

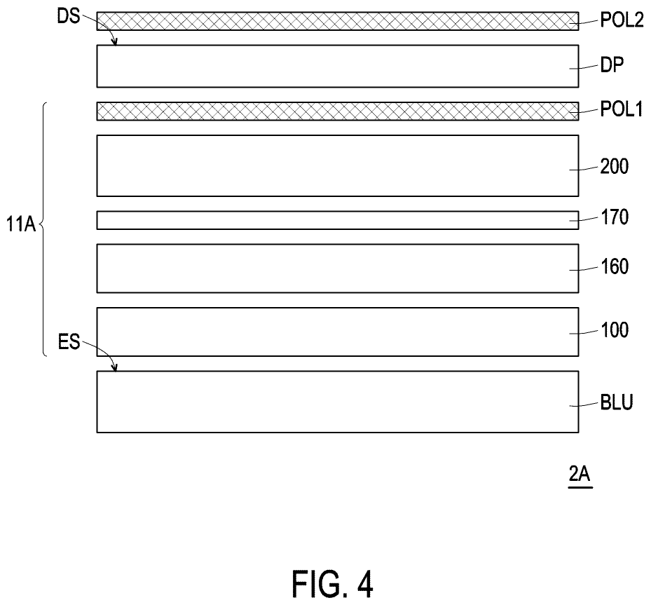

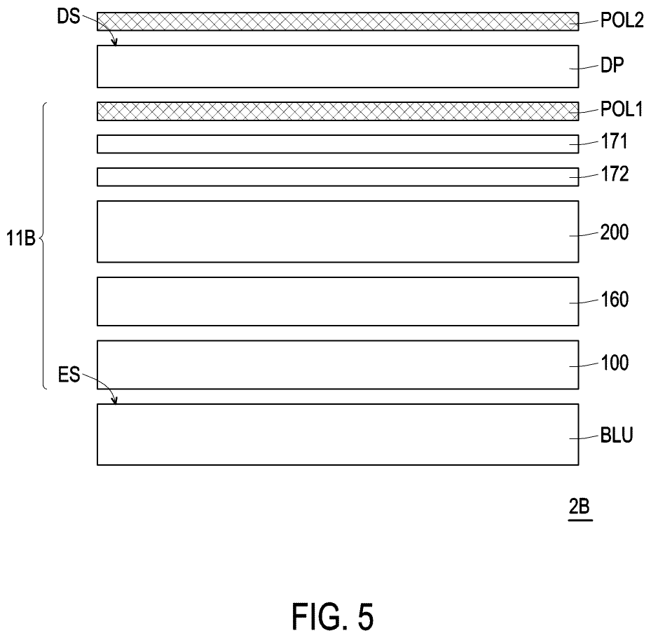

FIGS. 4 and 5 are schematic cross-sectional views of display devices according to other modified embodiments of the disclosure. Specifically, the anti-peep module (e.g., the anti-peep module 10 or the anti-peep module 10A) may further increase an anti-peep range through a configuration of a compensation film. For example, in the modified embodiment of FIG. 4, an anti-peep module 11A of a display device 2A may further include a compensation film 170 disposed between the first polarizer POL1 and the viewing angle limiter 160. The compensation film 170 is, for example, an A-plate compensation film. However, the disclosure is not limited thereto. In another modified embodiment of FIG. 5, an anti-peep module 11B of a display device 2B may further include two compensation films 171 and 172, and the compensation film 171 and the compensation film 172 are, for example, A-plate compensation films with two optical axes intersecting. An in-plane phase retardation of the A-plate compensation film may be between 100 nm and 350 nm.

It is particularly noted that in the display device 2A in FIG. 4, the compensation film 170 may be disposed between the electrically controlled phase retarder 200 and the viewing angle limiter 160. However, in the display device 2B in FIG. 5, the two compensation films 171 and 172 may also be disposed between the electrically controlled phase retarder 200 and the first polarizer POL1. An optical axis of the compensation film 171 close to the first polarizer POL1 is perpendicular to the absorption axis AX1 of the first polarizer POL1, and an optical axis of the compensation film 172 is parallel to the absorption axis AX1 of the first polarizer POL1.

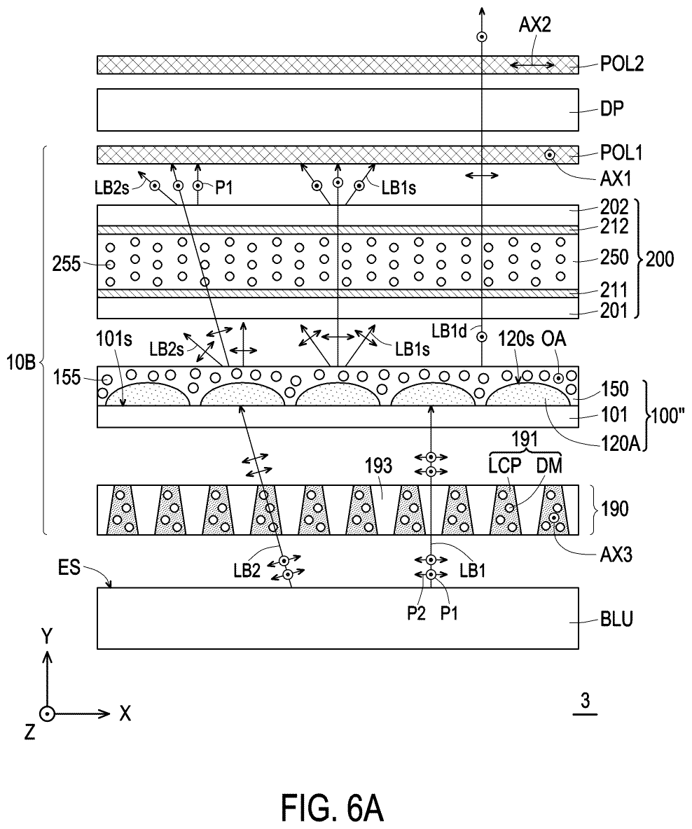

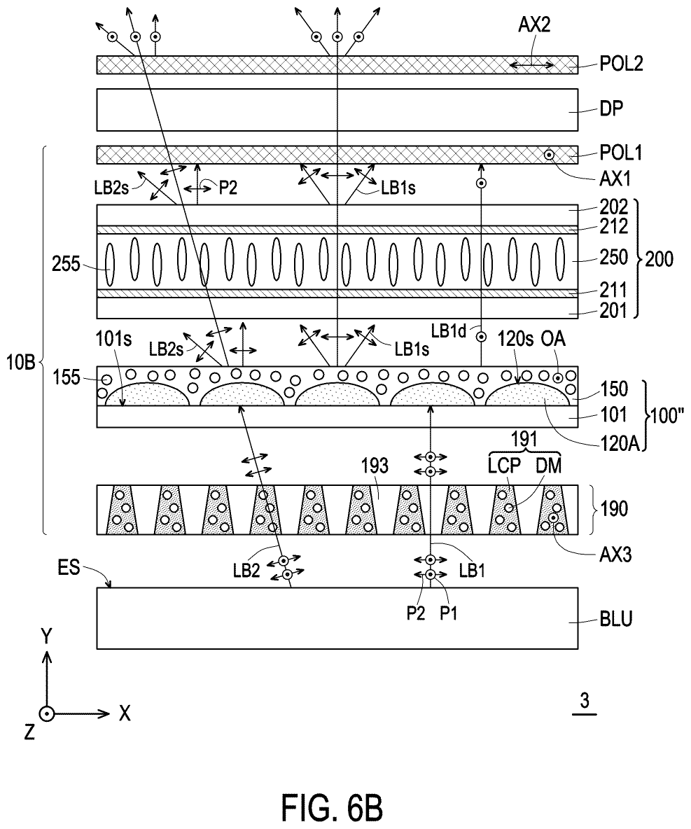

FIGS. 6A and 6B are schematic cross-sectional views of a display device in different operation modes according to the third embodiment of the disclosure. Referring to FIGS. 6A and 6B, compared to the display device 1 in FIG. 1A, an anti-peep module 10B of a display device 3 in this embodiment further includes a viewing angle control polarization film 190 disposed to overlap the electrically controlled phase retarder 200. In this embodiment, the viewing angle control polarization film 190 may be disposed between the backlight module BLU and the anisotropic diffusion film 100.

In this embodiment, the viewing angle control polarization film 190 may include multiple polarization portions 191 and multiple light transmission portions 193. The polarization portions 191 and the light transmission portions 193 may be alternately arranged along the direction X and extend in the direction Z. Each of the polarization portions 191 may have an absorption axis AX3 parallel to the direction Z. A material of the polarization portion 191 may include a dichroic absorption material, and a material of the light transmission portion 193 may include a polymer material such as acrylic, silicone, epoxy resins, etc. For example, the dichroic absorption material may include a liquid crystal polymer LCP and the dye molecules DM, and the dye molecules DM are dispersedly disposed in the liquid crystal polymer LCP. However, the disclosure is not limited thereto. In another modified embodiment, the dichroic absorption material may further be formed by curing lyotropic liquid crystals and then soaking them in a dye.

On the other hand, different from the anisotropic diffusion film 100 in FIG. 1A, a refractive index of an optical microstructure 120A of an anisotropic diffusion film 100″ in this embodiment may be equal to the second refractive index of the liquid crystal layer 150 along the direction Z. That is, in this embodiment, the polarization direction of the linear polarization of the light scattered by the anisotropic diffusion film 100″ is parallel to the XY plane.

Since other components and configuration relationships of the display device 3 in this embodiment are similar to those of the display device 1 in FIG. 1A, relevant paragraphs of the aforementioned embodiment may be referred for detailed descriptions. Therefore, the same details will not be repeated in the following. Only differences in the operating principles between the display device 3 in this embodiment and the display device 1 in FIG. 1A will be described below.

Referring to FIG. 6A, in this embodiment, the light LB1 from the backlight module BLU and incident to the viewing angle control polarization film 190 in the forward direction may pass through the light transmission portion 193 with the negligible light energy loss and maintain a non-polarized state. For the light LB2 from the backlight module BLU and incident to the viewing angle control polarization film 190 in the oblique direction, the light component with the first linear polarization P1 thereof is absorbed by the viewing angle control polarization film 190 because the polarization direction is parallel to the absorption axis AX3 of the polarization portion 191. Therefore, the light LB2 in the non-polarized state forms the light LB2 with the second linear polarization P2 after passing through the polarization portion 191 of the angle of the viewing angle control polarization film 190.

When the light LB1 in the non-polarized state passes through the anisotropic diffusion film 100″, the light component with the second linear polarization P2 in the light LB1 is deflected at the interface 120s between the optical microstructure 120A and the liquid crystal layer 150 due to differences in the refractive index between the optical microstructure 120A and the liquid crystal layer 150 in the direction X. Similarly, the light LB2 with the second linear polarization P2 is also deflected at the interface 120s between the optical microstructure 120A and the liquid crystal layer 150. On the contrary, the light component with the first linear polarization P1 in the light LB1 is not deflected at the interface 120s between the optical microstructure 120A and the liquid crystal layer 150 because there is no substantial difference in the refractive index between the optical microstructure 120A and the liquid crystal layer 150 in the direction Z.

That is, the light component with the second linear polarization P2 in the light LB1 and the light LB2 with the second linear polarization P2 are scattered when passing through the anisotropic diffusion film 100″ (as shown by the light LB1s and the light LB2s), while the light component with the first linear polarization P1 in the light LB1 is not scattered when passing through the anisotropic diffusion film 100″ (as shown by the light LB1d).

In this embodiment, the electronically controlled phase retarder 200 that is not enabled may have the phase retardation of A2. Therefore, the scattered lights LB1s and LB2s and the non-scattered light LB1d form the lights LB1s and LB2s with the first linear polarization P1 and the light LB1d with the second linear polarization P2 respectively after passing through the electrically controlled phase retarder 200 that is not enabled. Therefore, the scattered lights LB1s and LB2s may not pass through the first polarizer POL1. On the contrary, the non-scattered light LB1d may pass through the display panel DP and form the emitted light with the first linear polarization P1. That is, when the electrically controlled phase retarder 200 is not enabled and has the phase retardation of λ/2, only the non-scattered light LB1d may be emitted. That is, the display device 3 is operated in the anti-peep display mode.

Referring to FIG. 6B, when the electrically controlled phase retarder 200 is enabled and has the phase retardation of 0λ, the scattered lights LB1s and LB2s with the second linear polarization P2 still maintain the second linear polarization P2 after passing through the electrically controlled phase retarder 200, and thus may pass through the first polarizer POL1, the display panel DP, and the second polarizer POL2 and form the emitted light with the first linear polarization P1. On the contrary, the non-scattered light LB1d with the first linear polarization P1 still maintains the first linear polarization P1 after passing through the electrically controlled phase retarder 200, and thus may not pass through the first polarizer POL1. That is, when the electrically controlled phase retarder 200 is enabled and has the phase retardation of 0λ, only the scattered lights LB1s and LB2s may be emitted. That is, the display device 3 is operated in the sharing display mode.

It is particularly noted that compared to the anti-peep module 10 in FIGS. 1A and 1B, the anti-peep module 10B in this embodiment may further improve an anti-peep effect of the display device 3 by disposing the viewing angle control polarization film 190. In addition, the viewing angle control polarization film 190 in this embodiment may further significantly improve the issue of light energy loss of the current anti-peep sheet at the normal viewing angle, which helps to improve anti-peep display brightness of the display device 3.

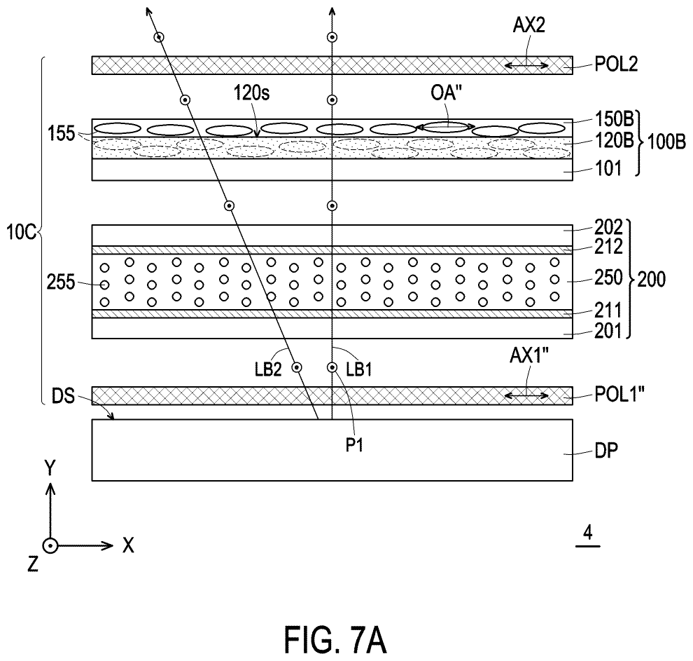

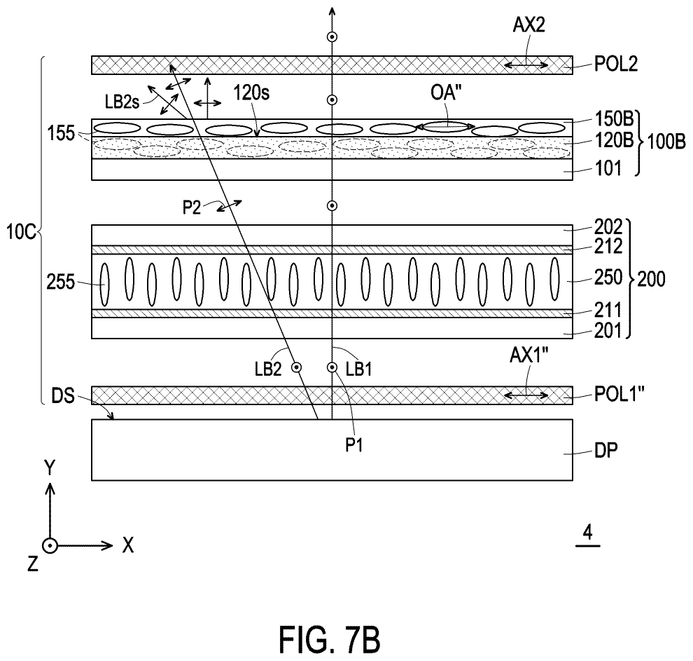

FIGS. 7A and 7B are schematic cross-sectional views of a display device in different operation modes according to the fourth embodiment of the disclosure. Referring to FIGS. 7A and 7B, a main difference between a display device 4 in this embodiment and the display device 1 in FIG. 1 is that a configuration of the anti-peep module is different. In this embodiment, the display panel DP may be a non-self-luminous display panel, such as a liquid crystal display panel, or a self-luminous display panel, such as an organic light emitting diode display panel. A first polarizer POL1″ and the second polarizer POL2 are both disposed on one side of the display surface DS of the display panel DP, and the electrically controlled phase retarder 200 and a anisotropic diffusion film 100B are disposed between the first polarizer POL1″ and the second polarizer POL2. That is, an anti-peep module 10C in this embodiment is disposed on the one side of the display surface DS of the display panel DP.

In this embodiment, a first absorption axis AX1″ of the first polarizer POL1″ may be parallel to the second absorption axis AX2 of the second polarizer POL2, and both the first absorption axis AX1″ and the second absorption axis AX2 are parallel to the direction X. However, the disclosure is not limited thereto. In other modified embodiments, the first absorption axis AX1″ and the second absorption axis AX2 may also be perpendicular to the direction X. In this embodiment, the electrically controlled phase retarder 200 is located between the anisotropic diffusion film 100B and the first polarizer POL1″, and the anisotropic diffusion film 100B is located between the second polarizer POL2 and the electrically controlled phase retarder 200.

It is particularly noted that in this embodiment, multiple optical microstructures 120B of the anisotropic diffusion film 100B are arranged along the direction Z and extend in the direction X, and an optical axis OA″ of a liquid crystal layer 150B directly covering the optical microstructures 120B is parallel to the direction X. However, the disclosure is not limited thereto. In other modified embodiments, an extension direction of the optical microstructures 120B may also be parallel to the direction Z. That is, the optical axis OA″ of the liquid crystal layer 150B may also be parallel to the direction Z. On the other hand, in this embodiment, a refractive index of the optical microstructure 120B may be equal to a first refractive index of the liquid crystal layer 150B along the direction Z.

Operating principles of the display device 4 is exemplarily described below. Referring to FIG. 7A, the light LB1 and the light LB2 from the display panel DP are incident to the first polarizer POL1″ at a forward viewing angle and an oblique viewing angle respectively, and have the first linear polarization P1 after passing through the first polarizer POL1″. In this embodiment, in the electrically controlled phase retarder 200 that is not enabled, the molecular long axes (or optical axes) of the liquid crystal molecules 255 of the liquid crystal layer 250 may be parallel to the polarization direction of the first linear polarization P1. Therefore, no matter the forward incident light LB1 or the oblique incident light LB2, both still maintain the first linear polarization P1 after passing through the electrically controlled phase retarder 200.

The light LB1 and the light LB2 incident to the anisotropic diffusion film 100B and having the first linear polarization P1 are not deflected at the interface 120s between the optical microstructure 120B and the liquid crystal layer 150B because there is no substantial difference in the refractive index between the optical microstructure 120B and the liquid crystal layer 150B in the direction Z. That is, neither the light LB1 nor the light LB2 is scattered when passing through the anisotropic diffusion film 100B. Since the light LB1 and the light LB2 passing through the anisotropic diffusion film 100B still maintain the first linear polarization P1, and the polarization direction of the first linear polarization P1 is perpendicular to the second absorption axis AX2 of the second polarizer POL2, the light LB1 and the light LB2 may pass through the second polarizer POL2 to be emitted from the display device 4. At this time, the display device 4 is operated in the sharing display mode.

Referring to FIG. 7B, when the electrically controlled phase retarder 200 is enabled, the liquid crystal molecules 255 of the liquid crystal layer 250 are arranged obliquely along a YZ plane toward the direction Y. The polarization direction of the first linear polarization P1 of the light LB1 incident to the electrically controlled phase retarder 200 in the forward direction is parallel to the YZ plane. Therefore, after passing through the electrically controlled phase retarder 200, the light LB1 still maintains the first linear polarization P1. However, the polarization direction of the first linear polarization P1 of the light LB2 incident to the electrically controlled phase retarder 200 in the oblique direction is neither perpendicular nor parallel to the molecular long axes of the liquid crystal molecules 255. Therefore, after passing through the electrically controlled phase retarder 200, the first linear polarization P1 of the light LB2 is converted into the second linear polarization P2.

The light LB1 incident to the anisotropic diffusion film 100B and having the first linear polarization P1 is not deflected at the interface 120s between the optical microstructure 120B and the liquid crystal layer 150B because there is no substantial difference in the refractive index between the optical microstructure 120B and the liquid crystal layer 150B in the direction Z. However, the light LB2 incident to the anisotropic diffusion film 100B and having the second linear polarization P2 is deflected at the interface 120s between the optical microstructure 120B and the liquid crystal layer 150B due to the difference in the refractive index between the optical microstructure 120B and the liquid crystal layer 150B in the direction X. That is, the light LB1 is not scattered when passing through the anisotropic diffusion film 100B, while the light LB2 is scattered when passing through the anisotropic diffusion film 100B and form the scattered light LB2s with the second linear polarization P2.

Since the light LB1 passing through the anisotropic diffusion film 100B still maintains the first linear polarization P1, the light LB1 may pass through the second polarizer POL2 to be emitted from the display device 4. On the contrary, the light LB2s scattered by the anisotropic diffusion film 100B has the second linear polarization P2 and is absorbed when passing through the second polarizer POL2. At this time, the display device 4 is operated in the anti-peep display mode.

In another modified embodiment, in order to improve the anti-peep range, at least one compensation film may be further disposed between the first polarizer POL1″ and the second polarizer POL2, such as a C-plate compensation film with an out-of-plane phase retardation (Rth) between 200 nm and 800 nm, two A-plate compensation films with intersecting optical axes and the respective in-plane phase retardation (RO) between 200 nm and 700 nm, or a biaxial compensation film with the in-plane phase retardation less than 100 nm and the out-of-plane phase retardation between 100 nm and 300 nm.

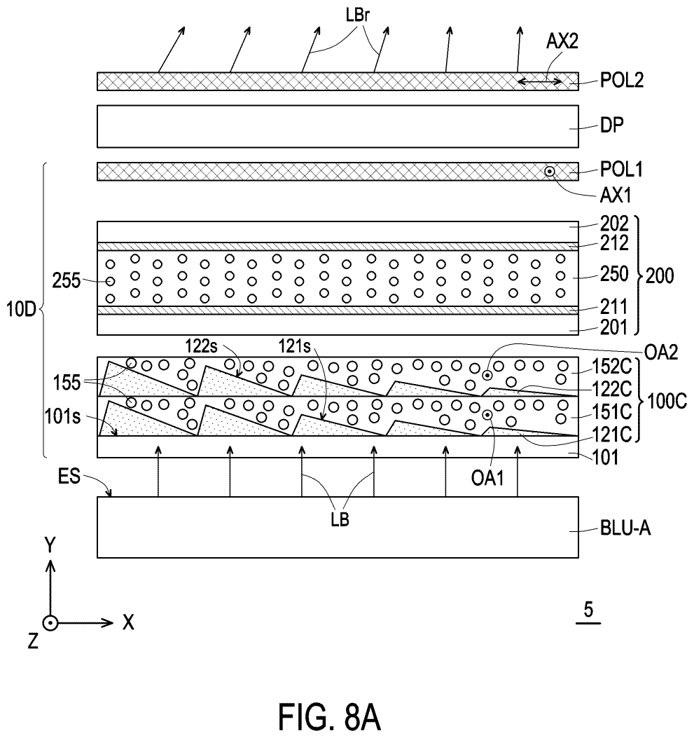

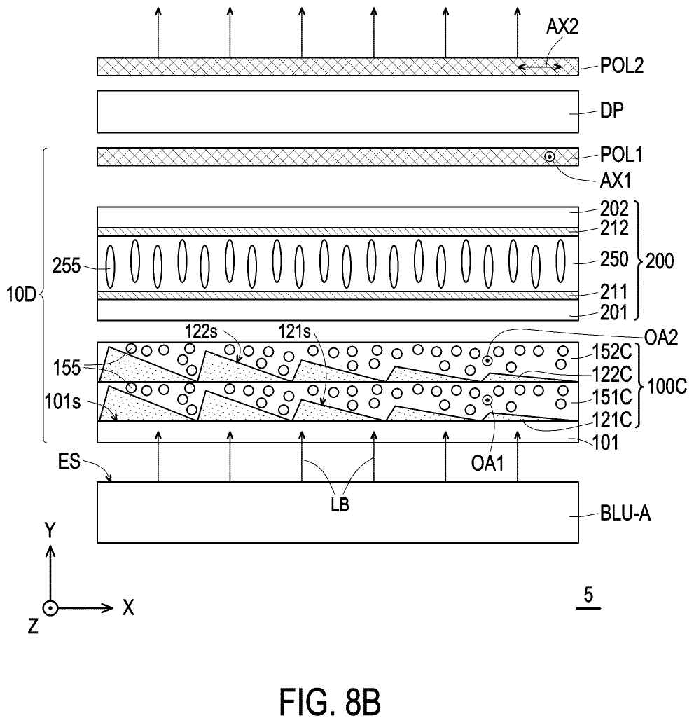

FIGS. 8A and 8B are schematic cross-sectional views of a display device in different operation modes according to the fifth embodiment of the disclosure. Referring to FIGS. 8A and 8B, a main difference between a display device 5 in this embodiment and the display device 1 in FIG. 1A is that functionality of the anisotropic diffusion film is different. Specifically, in this embodiment, an anisotropic diffusion film 100C of the display device 5 is, for example, a stacked structure of two sets of optical microstructure layers and the liquid crystal layer. For example, the anisotropic diffusion film 100C may include multiple first optical microstructures 121C, a first liquid crystal layer 151C, multiple second optical microstructures 122C, and a second liquid crystal layer 152C sequentially stacked on the disposed surface 101s of the substrate 101.

The first optical microstructures 121C may be arranged along the direction X and extend in the direction Z. The first liquid crystal layer 151C directly covers the first optical microstructures 121C. The second optical microstructures 122C may be arranged along the direction X and extend in the direction Y. The second liquid crystal layer 152C directly covers the second optical microstructures 122C. The optical axis OA1 of the first liquid crystal layer 151C and the optical axis OA2 of the second liquid crystal layer 152 are parallel to each other, and are both parallel to the direction Z.

Since operating principles of the anisotropic diffusion film 100C in this embodiment are similar to those of the anisotropic diffusion film 100 in FIG. 1A, relevant paragraphs of the aforementioned embodiment may be referred for detailed descriptions. Therefore, the same details will not be repeated in the following. Only functional differences between the anisotropic diffusion film 100C in this embodiment and the anisotropic diffusion film 100 in FIG. 1A will be described below.

In this embodiment, the first optical microstructures 121C and the second optical microstructures 122C of the anisotropic diffusion film 100C are multiple prism structures, and a slope (relative to the disposed surface 101s) of the interface (e.g., an interface 121s and an interface 122s) between each of the optical microstructures and the liquid crystal layer changes (e.g., increases gradually) with different positions on the direction X. Through such design, the incident lights LB may generate different deflection angles when passing through different prism structures.

For example, a backlight module BLU-A in this embodiment may be a light source with high directivity (e.g., the range of the light emitting angle less than or equal to 60 degrees or 90 degrees), and the emitted lights LB are all concentrated on the normal viewing angle. Similar to the display device 1 in FIG. 1A, when the electrically controlled phase retarder 200 in this embodiment is not enabled, the lights LB deflected by the anisotropic diffusion film 100C form multiple deflected lights LBr (as shown in FIG. 8A) with gradually changing light directions after passing through the first polarizer POL1, the display panel DP, and the second polarizer POL2.

Similar to the display device 1 in FIG. 1B, when the electrically controlled phase retarder 200 in this embodiment is enabled, the multiple lights LB deflected by the anisotropic diffusion film 100C are absorbed by the first polarizer POL1, and only the light components of the lights LB that are not deflected by the anisotropic diffusion film 100C may pass through the first polarizer POL1, the display panel DP, and the second polarizer POL2, and maintain light emission in the forward direction (as shown in FIG. 8B).

That is, in this embodiment, an anti-peep module 10D may be substantially a control module that may control a light emitting direction of the display device 5. That is, function of the anisotropic diffusion film in the disclosure is not limited to a light diffusion effect (e.g., the anisotropic diffusion films of the above embodiments), but may also be a diffraction effect for light sources with the high directivity.

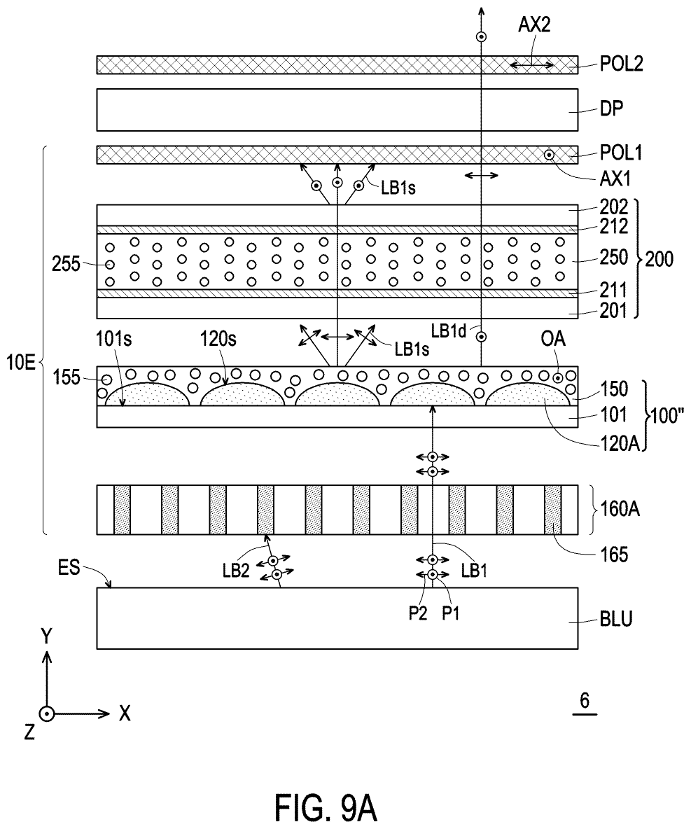

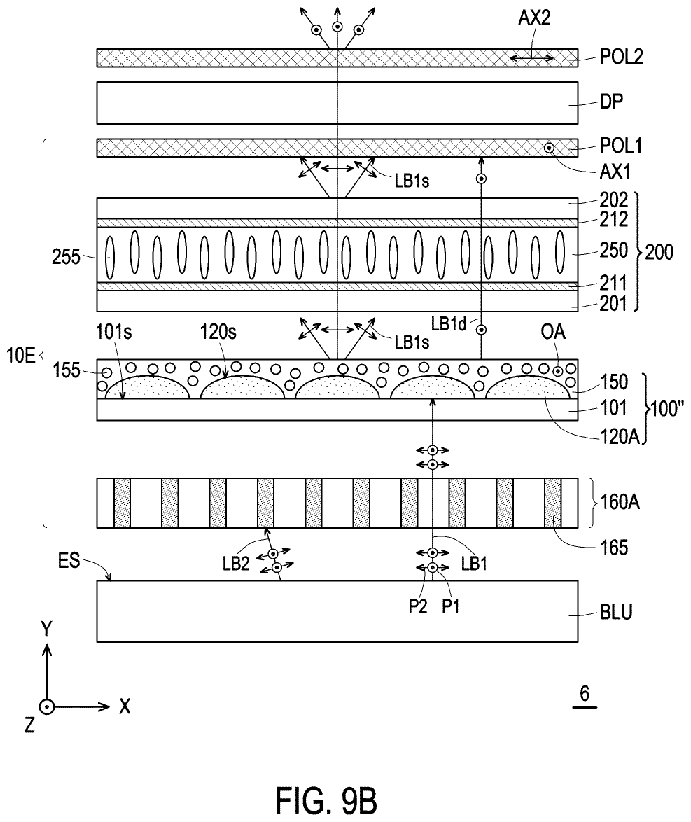

FIGS. 9A and 9B are schematic cross-sectional views of a display device in different operation modes according to the sixth embodiment of the disclosure. Referring to FIGS. 9A and 9B, in an anti-peep module 10E of a display device 6 in this embodiment, the viewing angle control polarization film 190 of the display device 3 in FIG. 6A is replaced with a viewing angle limiter 160A. In this embodiment, the viewing angle limiter 160A is, for example, a light control film (LCF) that limits the range of the light emitting viewing angle of the transmitted light.

For example, the viewing angle limiter 160A may be provided with multiple light shielding walls 165, and the light shielding walls 165 are arranged at intervals along the direction X and extend in the direction Z. The light shielding walls 165 are configured to at least partially reflect or absorb the light, and the light may pass through the two adjacent light shielding walls 165. It is worth mentioning that an arrangement direction of the light shielding walls 165 may define an anti-peep axial direction of the display device 6. That is, the anti-peep axial direction is parallel to the direction X.

Since other components and configuration relationships of the display device 6 in this embodiment are similar to those of the display device 3 in FIG. 6A, relevant paragraphs of the aforementioned embodiment may be referred for detailed descriptions. Therefore, the same details will not be repeated in the following. Only differences in the operating principles between the display device 6 in this embodiment and the display device 3 in FIG. 6A will be described below.

Different from the light LB2 in FIG. 6A which may partially penetrate through the polarization portion 191 of the viewing angle control polarization film 190, the light shielding wall 165 in this embodiment absorbs or reflects the light LB2, so that the light LB2 may not pass through the viewing angle limiter 160A. That is, by disposing the viewing angle limiter 160A between the backlight module BLU and the anisotropic diffusion film 100″, the range of the light emitting viewing angle of the backlight module BLU may be reduced, thereby improving anti-peep performance of the display device 6. Since operating principles of other film layers of the display device 6 are similar to those of the display device 3 in FIG. 6A, relevant paragraphs of the aforementioned embodiment may be referred for detailed descriptions. Therefore, the same details will not be repeated in the following.

Based on the above, in the anti-peep module and the display device according to an embodiment of the disclosure, the anisotropic diffusion film has polarization direction selectivity for the diffusion effect of the incident light, and the first absorption axis of the first polarizer is disposed to be parallel or perpendicular to the extension direction of the optical microstructure of the anisotropic diffusion film. By using the electrically controlled phase retarder to adjust the polarization state of the light incident to or emitted from the anisotropic diffusion film, the display device may be switched between the sharing display mode and the anti-peep display mode. By disposing the anisotropic diffusion film, the anti-peep module and the display device in the embodiment of the disclosure have at least one of the following advantages. In addition to further improving the anti-peep effect of the anti-peep module, the range of the field of view of the display device in the sharing display mode may also be increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An anti-peep module, wherein the anti-peep module comprises an anisotropic diffusion film, an electrically controlled phase retarder, and a first polarizer, wherein
the anisotropic diffusion film comprises a substrate, a plurality of first optical microstructures, and a first liquid crystal layer, wherein
the substrate has a disposed surface;
the first optical microstructures are disposed on the disposed surface of the substrate, the first optical microstructures are arranged along a first direction and extend in a second direction, the first direction and the second direction intersect each other, and the first direction and the second direction are parallel to the disposed surface; and
the first liquid crystal layer is disposed on the substrate and directly covers the first optical microstructures, an orthographic projection of an optical axis of the first liquid crystal layer on the disposed surface is parallel to the second direction, the first liquid crystal layer has a first refractive index and a second refractive index different from each other along the first direction and the second direction respectively, and a difference value of a refractive index of the first optical microstructures and one of the first refractive index and the second refractive index is greater than or equal to 0.05;
the electrically controlled phase retarder is disposed to overlap the anisotropic diffusion film; and
the first polarizer is disposed to overlap the electrically controlled phase retarder, the first polarizer has a first absorption axis, and an axial direction of the first absorption axis is parallel to or perpendicular to the second direction.

2. The anti-peep module according to claim 1, wherein the electrically controlled phase retarder is located between the anisotropic diffusion film and the first polarizer.

3. The anti-peep module according to claim 1, wherein the anti-peep module further comprises a viewing angle limiter, wherein
the viewing angle limiter is disposed between the anisotropic diffusion film and the electrically controlled phase retarder, and comprises a polymer substrate and a plurality of dye molecules, wherein
the dye molecules are dispersedly disposed in the polymer substrate, the dye molecules have a first absorption coefficient in a thickness direction of the polymer substrate, the dye molecules have a second absorption coefficient in a direction perpendicular to the thickness direction, and a ratio of the first absorption coefficient to the second absorption coefficient is between 10 and 1000.

4. The anti-peep module according to claim 3, wherein the anti-peep module further comprises at least one compensation film, wherein
the at least one compensation film is disposed between the viewing angle limiter and the first polarizer, and an in-plane phase retardation of the at least one compensation film is between 100 nm and 350 nm.

5. The anti-peep module according to claim 1, wherein the anti-peep module further comprises a viewing angle control polarization film, wherein
the viewing angle control polarization film is disposed to overlap the electrically controlled phase retarder and comprises a plurality of polarization portions and a plurality of light transmission portions, wherein
the polarization portions and the light transmission portions are alternately arranged along the first direction and extend in the second direction, the polarization portions have an absorption axis, and an axial direction of the absorption axis is parallel to the second direction.

6. The anti-peep module according to claim 5, wherein the polarization portions comprise a liquid crystal polymer and a plurality of dye molecules, wherein
the dye molecules are dispersedly disposed in the liquid crystal polymer.

7. The anti-peep module according to claim 1, wherein the first optical microstructures are a plurality of prism structures.

8. The anti-peep module according to claim 1, wherein the anti-peep module further comprises a second polarizer, wherein
the second polarizer has a second absorption axis, wherein the anisotropic diffusion film and the electrically controlled phase retarder are disposed between the first polarizer and the second polarizer, and the second absorption axis of the second polarizer is parallel to the first absorption axis of the first polarizer.

9. The anti-peep module according to claim 8, wherein the electrically controlled phase retarder is located between the anisotropic diffusion film and the second polarizer.

10. The anti-peep module according to claim 1, wherein the anisotropic diffusion film further comprises a plurality of second optical microstructures and a second liquid crystal layer, wherein
the second optical microstructures are disposed on the first liquid crystal layer, and the second optical microstructures are arranged along the first direction and extend in the second direction; and
the second liquid crystal layer is disposed on the first liquid crystal layer and directly covers the second optical microstructures, wherein an optical axis of the second liquid crystal layer is parallel to the second direction, and the second liquid crystal layer has a third refractive index and a fourth refractive index different from each other along the first direction and the second direction respectively, wherein a refractive index of the second optical microstructures is equal to the third refractive index or the fourth refractive index.

11. The anti-peep module according to claim 10, wherein a cross-sectional outline of each of the first optical microstructures is different from a cross-sectional outline of each of the second optical microstructures.

12. The anti-peep module according to claim 1, wherein an in-plane phase retardation of the substrate of the anisotropic diffusion film is less than 50 nm.

13. The anti-peep module according to claim 1, wherein the refractive index of the first optical microstructures is equal to the other of the first refractive index and the second refractive index.

14. A display device, wherein the display device comprises a display panel and an anti-peep module, wherein
the anti-peep module is disposed to overlap the display panel and comprises an anisotropic diffusion film, an electrically controlled phase retarder, and a first polarizer, wherein
the anisotropic diffusion film comprises a substrate, a plurality of first optical microstructures, and a first liquid crystal layer, wherein
the substrate has a disposed surface;
the first optical microstructures are disposed on the disposed surface of the substrate, the first optical microstructures are arranged along a first direction and extend in a second direction, the first direction and the second direction intersect each other, and the first direction and the second direction are parallel to the disposed surface; and
the first liquid crystal layer is disposed on the substrate and directly covers the first optical microstructures, an orthographic projection of an optical axis of the first liquid crystal layer on the disposed surface is parallel to the second direction, the first liquid crystal layer has a first refractive index and a second refractive index different from each other along the first direction and the second direction respectively, and a difference value of a refractive index of the first optical microstructures and one of the first refractive index and the second refractive index is greater than or equal to 0.05;
the electrically controlled phase retarder is disposed to overlap the anisotropic diffusion film; and
the first polarizer is disposed to overlap the electrically controlled phase retarder, the first polarizer has a first absorption axis, and an axial direction of the first absorption axis is parallel to or perpendicular to the second direction.

15. The display device according to claim 14, wherein the display device further comprises a backlight module, wherein
the backlight module has a light emitting surface, wherein the display panel and the anti-peep module are disposed on one side of the light emitting surface of the backlight module, and the anti-peep module is located between the display panel and the backlight module.

16. The display device according to claim 15, wherein the anti-peep module further comprises a viewing angle limiter, wherein
the viewing angle limiter is disposed between the backlight module and the anisotropic diffusion film and comprises a plurality of light shielding walls, and the light shielding walls are arranged along the first direction and extend in the second direction.
